(19) United States
(12) Patent Application Publication
(10) Pub. No.: US 2023/0128217 A1
(43) Pub. Date: Apr. 27, 2023

(54) CLOUD SYSTEM

(71) Applicant: FANUC CORPORATION, Yamanashi (JP)

(72) Inventors: Yutaka SAITOU, Yamanashi (JP); Masao KAMIGUCHI, Yamanashi (JP)

(21) Appl. No.: 17/904,875

(22) PCT Filed: Feb. 25, 2021
(86) PCT No.: PCT/JP2021/007062

§ 371 Date: Aug. 24, 2022

(30) Foreign Application Priority Data
Feb. 26, 2020 (JP) 2020-030505

(51) Int. Cl. H04L 9/40

(52) U.S. Cl. CPC H04L 63/205

(57) ABSTRACT

A cloud system includes a first server configured to receive information related to a tool, register a tool constructed based on the received information related to a tool, and provide the registered tool via a tool store, and a second server configured to acquire the tool provided by the tool store, create a service based on the tool and service creation data, and provide the created service via a service store.

### TECHNICAL FIELD

The present invention relates to a cloud system.

### BACKGROUND ART

Business operators conducting businesses employing industrial machines such as machine tools or robots sell products made by processing materials using industrial machines, parts, peripherals, etc. In addition, They have a desire to provide a maintenance/inspection service of these obtained products or a service related to the products to a user, etc. of the products using a cloud. In such a case, even though the business operator has an idea of the service, it may be necessary to develop software to build the service, and thus it is difficult to easily provide the service. In particular, in order to sell a plurality of services, it is necessary to develop a plurality of services, and thus it costs a lot to develop the services themselves.

In order for a business operator to provide a service, a method of providing the service is important in addition to the development cost. As a method of providing a service, there is a method of providing a service using an EC site. In this method, it is necessary to ensure know-bows required for service construction, data security, etc. in accordance with the content of the service to be provided. However, there are no mechanisms to address all the services intended to be provided by the business operator. For example, there are no mechanisms capable of adding security to where it is needed according to each service. Even when the mechanism is present, it costs a lot to independently develop a system for providing the services. As can be seen from the above, in order to provide a service in a cloud, there are two problems in that 1) a method capable of easily constructing a service and 2) a method capable of easily providing a service are required.

Note that Patent Document 1 describes that a computer network is used to provide core technology software such as data compression technology or language translation technology developed by a core technology software developer to an end user by an application service provider developing client software including a user interface suitable for the end user.

### CITATION LIST

### Patent Document

Patent Document 1: JP 2002-055819 A

### SUMMARY OF THE INVENTION

### Technical Problem

By using core software provided by a software developer, a business operator providing a service can reduce software development burden to some extent. However, the business operator providing the service needs to develop client software including a user interface to provide a function of this core software. In addition, it is necessary to independently consider a method of providing the developed software, and it is also necessary to reduce the cost in this respect.

For this reason, there is a desire for a mechanism capable of easily creating a service by providing a tool that can easily build a service, and adding individual data, know-bows, a service, security, etc. by a service provider using the provided tool.

### Solution to Problem

An aspect of the present invention is a cloud system including a first server including a tool registration unit configured to receive registration of a tool, and a tool store configured to provide the registered tool, and a second server including a tool acquisition unit configured to acquire the tool provided by the tool store, a service creation unit configured to create a service based on the tool and service creation data, and a service store configured to provide the service created by the service creation unit.

Another aspect of the present invention is a cloud system including a first server including a tool registration unit configured to receive registration of a tool, and a tool store configured to provide the registered tool, a second server including a tool acquisition unit configured to acquire the tool provided by the tool store, a service creation unit configured to create a service based on the tool and service creation data, and a service store configured to provide the service created by the service creation unit, and a third server including a service acquisition unit configured to acquire the service provided by the service store, and a service DX unit configured to use a service using the service.

According to one aspect of the present invention, a tool provider may sell a tool for constructing various services at a tool store, and a service provider may add data and know-bows of a company of the service provider to a tool and provide the tool to a service user through a service store. Therefore, the service provider may provide various services to the service user without developing software. In addition, since the service store is used as a service provision method, it is possible to digitize the business related to sales, and it is possible to obtain a digital transformation effect within the company of the service provider.

### BRIEF DESCRIPTION OF DRAWINGS

FIG. 1 is a diagram schematically illustrating an overall configuration of a cloud system according to an embodiment;

FIG. 2 is a diagram schematically illustrating a server configuration according to an embodiment;

FIG. 3 is a schematic functional block diagram of the cloud system according to the embodiment;

FIG. 4 is a diagram illustrating an example of a tool for creating a service;

FIG. 5 is a diagram illustrating an example of creating a manual search service by a document search service tool;

FIG. 6 is a diagram illustrating an example of creating a service by a service tool of a corporate SNS;

FIG. 7 is a diagram illustrating an example of a template in the service tool of the corporate SNS;

FIG. 8 is a schematic hardware configuration diagram of a computer included in the cloud system according to an embodiment;

FIG. 9 is a diagram schematically illustrating an overall configuration of a cloud system according to another embodiment; and

FIG. 10 is a schematic functional block diagram of the cloud system according to the other embodiment.

### DESCRIPTION OF EMBODIMENTS

Embodiments of the present invention will now be described with reference to the drawings.

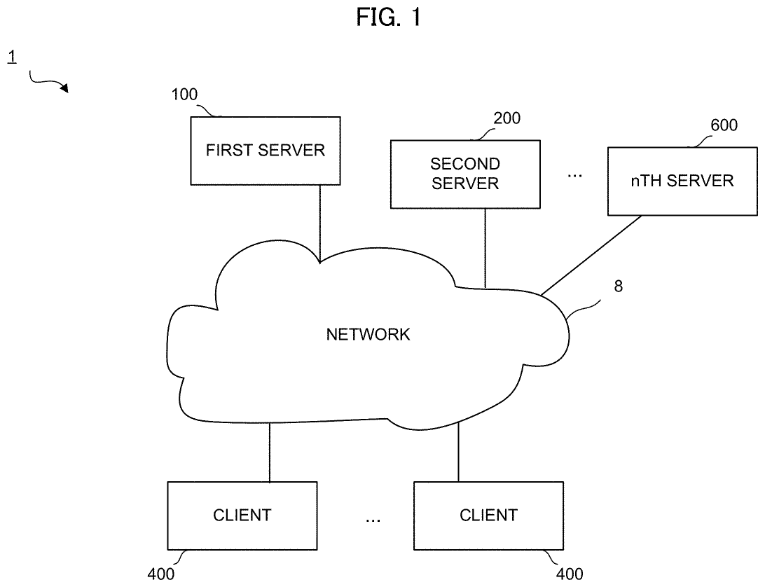

FIG. 1 is a diagram schematically illustrating an overall configuration of a cloud system according to a first embodiment of the present invention. The cloud system 1 according to the present embodiment is configured such that a first server 100, a second server 200, . . . an nth server 600 are connected to each other via a network 8. In the cloud system 1 according to the present embodiment, functions thereof are mainly provided by the first server 100 and the second server 200.

The first server 100 is that registers and provides tools required for constructing a service. The tools are created by a person who creates and provides the tools (hereinafter referred to as a tool provider).

The tool provider may be that providing a predetermined product or service to a businesses operator conducting business using an industrial machine such as, for example, a manufacturer of a controller for controlling an industrial machine, or a manufacturer of a management system for managing a manufacturing site where an industrial machine is installed.

The second server 200 is that registers and provides services created by a person who creates and provides the services (hereinafter referred to as a service provider). The service provider may be a business operator conducting business using an industrial machine such as, for example, a manufacturer that sells an industrial machine incorporating a controller purchased from a tool provider, or a manufacturer that sells a product manufactured by processing a material using an industrial machine.

A client 400 is a computer used when a service provided by the second server 200 is used. For example, a customer of a service provider uses the client 400.

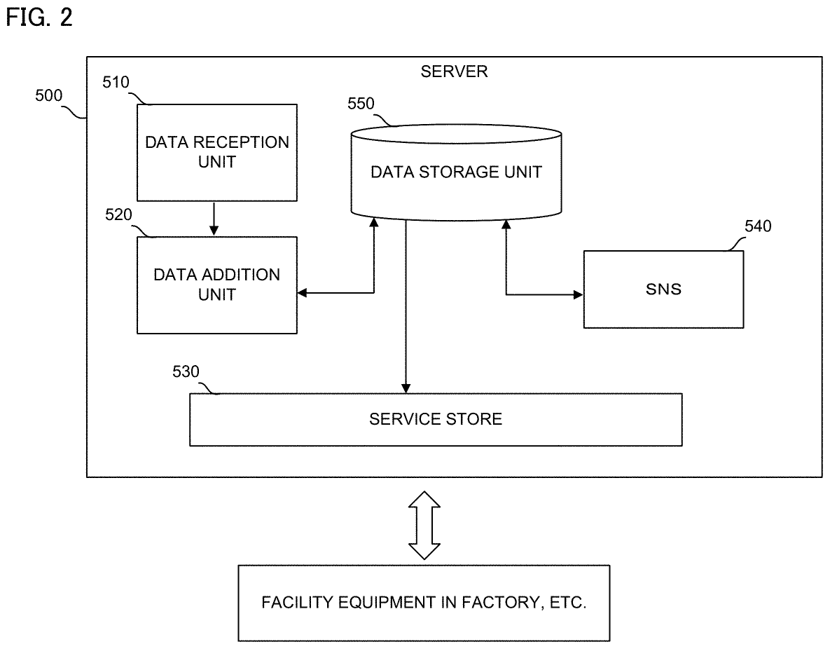

FIG. 2 illustrates a fundamental 1 configuration of functions of a server used in the present invention. Each block included in the server 500 illustrated in FIG. 2 illustrates a fundamental function that needs to be assigned to a server such as the first server 100 or the second server 200.

A data reception unit 510 is a part responsible for tool acquisition, service acquisition, data acquisition, etc. from other servers. A data addition unit 520 is a part responsible for tool registration, service creation, and service DX (Digital Transformation). These functions may be provided in independent parts on the server, respectively. In the present invention, these functions are separately implemented in the data reception unit 510 and the data addition unit 520 for convenience. A data storage unit 550 may store data such as tools or services, and data that can be stored is not limited thereto, and any data can be stored. The data storage unit 550 is connected to a SNS 540, and data used in the SNS 540 may be recorded in the data storage unit 550. Data stored in the data storage unit 550 may be revised by providing a data analysis function in the data addition unit 520. A service store 530 may sell tools or services stored in the data storage unit 550. Further, the server 500 may receive data of equipment in a factory using the data reception unit 510 via the cloud. By adding the data as mentioned above to the tools, it is possible to provide a factory visualization service, etc.

The functional configuration of the server 500 illustrated in FIG. 2 may not be used depending on the role of the server 500. In the functional configuration illustrated in FIG. 2, a function that is not used depending on the role thereof, for example, the service store 530 or the SNS 540 is configured to be allowed to be deleted by a user.

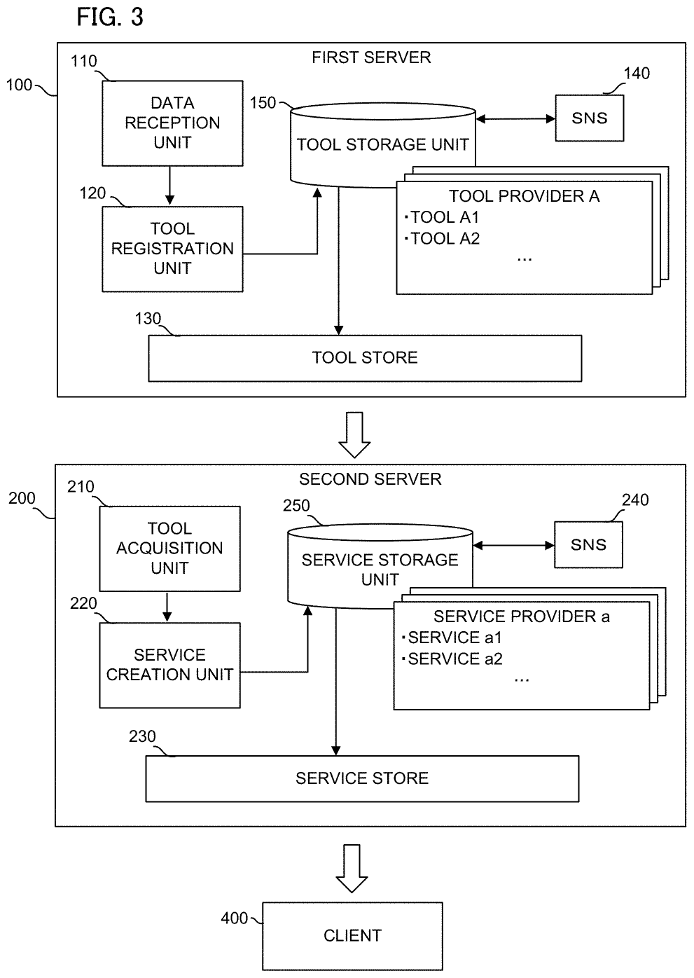

A flow of service provision using the first server 100 and the second server 200 will be described with reference to FIG. 3. The first server 100 receives information related to tools from a tool provider who uses the first server 100 via a data reception unit 110. Then, a tool registration unit 110 constructs a tool required for a service provider to construct a service based on the received information related to the tool, and registers the constructed tool in a tool storage unit 150. The tool registered by the tool provider is stored in the tool storage unit 150 for each tool provider. Then, the tool is sold to the service provider through a tool store 130.

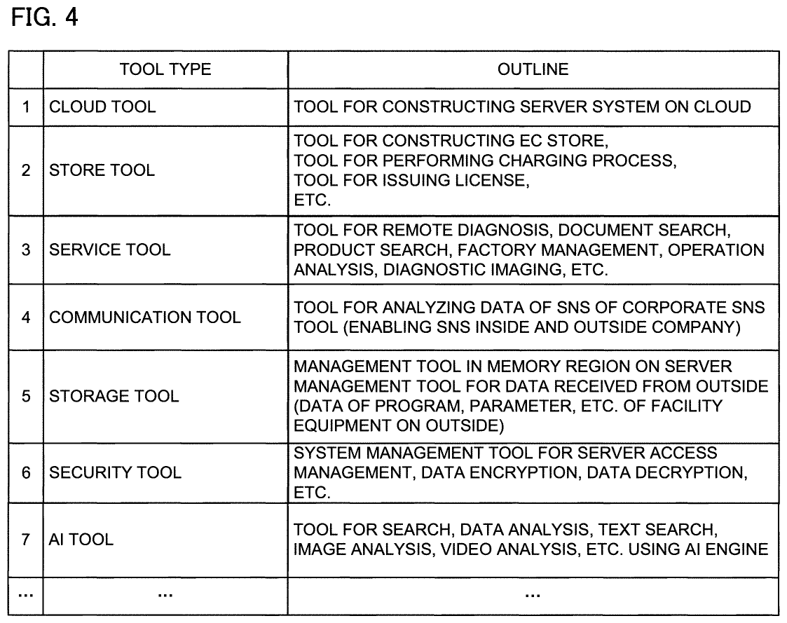

FIG. 4 illustrates an example of tools to be registered by the tool provider. These tools provided by the tool provider may be a software package or a software component capable of providing a predetermined service by combining service creation data such as predetermined data, contents, know-bows, or parameters. For example, the tools may be cloud tools for constructing a server system on a cloud (such as Puppet, Chef, etc.), store tools for constructing an EC store (such as SaaS, etc.), service tools for constructing services related to industrial machines such as remote diagnosis, manual search, product search, factory management, or diagnostic imaging, etc.

The service provider who uses the second server 200 acquires (purchases) a tool necessary for creating a service from the first server 100 via a tool acquisition unit 210. The service provider creates a service (software group that provides a service) using the acquired tool and individual data, know-bows, support information, etc. The service provider may construct a service by combining a plurality of tools. The service provider may acquire, for example, a cloud tool, a security tool, a service tool (document search), a communication tool (corporate SNS), and a store tool, and combine these tools with manual data of the industrial machine provided by the service provider, thereby creating a compressive service including a manual search service of the industrial machine provided by the service provider.

The service provider secures a region for providing a service on a cloud by using, for example, a cloud tool. In addition, a URL for accessing a region for providing a service is acquired, and enables data to be exchanged with the outside using the URL. Further, a security tool is set to protect data in a region accessible via the acquired URL and to monitor content of data access with the outside. Note that a method of logging in with other servers (horizontal integration, single login, etc.) is also ensured.

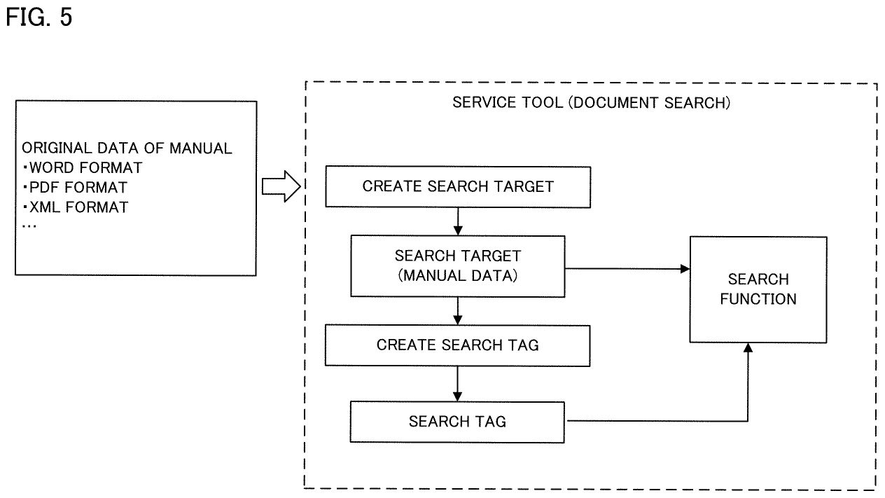

For example, as illustrated in FIG. 5, the service provider prepares original data (electronic data) of the manual used when creating a paper manual, an electronic manual, etc. As a data format, it is possible to use various types such as Microsoft WORD format, PDF format, and XML format. From the original data, manual data to be searched for is created. In this instance, a search result can be displayed in the minimum explanation units, by dividing the manual data into minimum explanation units (chapter, section, paragraph, etc.) to be hit on a searched word enables. It is preferable for the document search service tool to have such a data division function. The document search service tool has a function of extracting text features from the manual data given by the service provider.

For example, text may be decomposed by morphological analysis, and a frequently used terms may be extracted as feature of the manual data. The document search service tool may have a function such as AI (artificial intelligence) to add a search for a related word, etc. as a feature of the manual data. Then, the document search service tool creates each feature of the text as a search tag. A manual search service is created by incorporating the search tag and the manual data which is a search target created in this way. The manual search service provides the client 400 with an interface for using a search function. When a key for searching is input from the client 400, the manual search service compares search text with a search tag, and provides a hit search target to the client 400 as a search result.

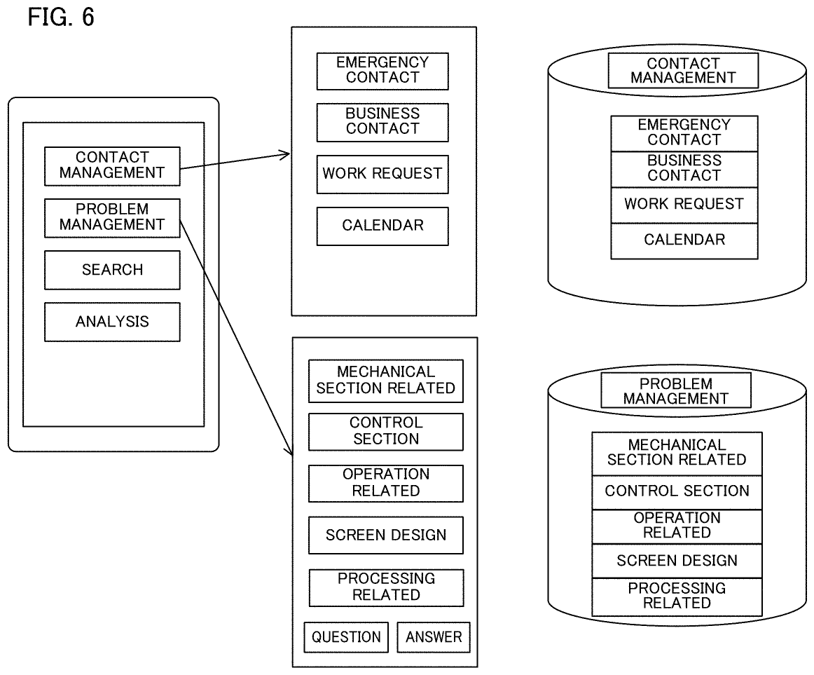

The service provider may provide a function of exchanging information using, for example, a communication tool (corporate SNS). The service provider uses the communication tool (corporate SNS) to create a corporate SNS service capable of tagging matters to be contacted by SNS, for example, as illustrated in FIG. 6, in a hierarchical menu format. This tagging is used to construct content of contact or content of consultation performed by a user of the service using the corporate SNS into knowledge by collecting information about each tag and organizing the information using AI, etc. later.

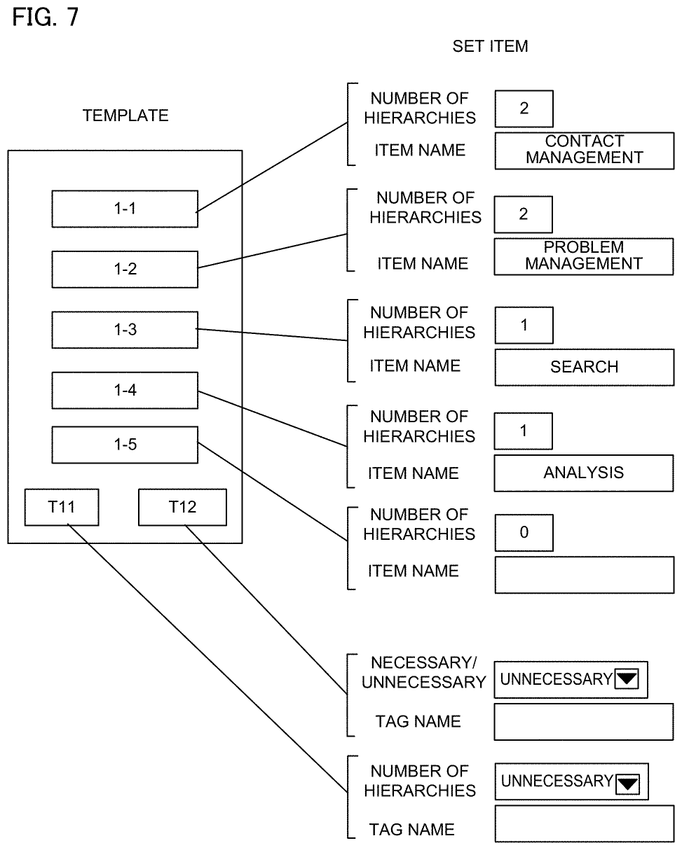

FIG. 7 is an example of an interface for creating a hierarchical menu. When the communication tool (corporate SNS) is executed, a template illustrated in FIG. 7 is displayed, and by setting a predetermined set value for each set item of the displayed template, it is possible to configure a hierarchical menu for tagging content posted on the corporate SNS. The depth of the hierarchy, tag names, etc. may be appropriately designed by the service provider according to the purpose of providing the service of a company of the service provider. Since an interface for templates or settings is developed by the tool provider and provided as a communication tool (corporate SNS), the service provider may provide the service only by setting parameters such as tags or stamps according to a request of a service user. In this case, software development is not required.

For example, the service provider may sell a service created using various tools to a service user using a store tool. Since this store is equipped with a payment function such as bank transfer or credit card, the service provider may rationalize payment related to a service sale by selecting an appropriate payment method, and may implement one form of digital transformation.

As another example, the service provider may use, for example, a service tool (product search) to provide a database service capable of searching for product photos and its processing programs, parameters, processing conditions, tool information, material information, etc. In addition, it is possible to create a diagnostic imaging service using a service tool (diagnostic imaging), an analysis service using an AI tool, etc.

The service created by the service provider is stored in a service storage unit 250 per each service provider. The service will then be sold to a customer who operates the client 400 via a service store 230.

As described above, in the cloud system 1 according to the present embodiment, using a tool provided by the service provider, the service provider may add data, parameters, know-bows, etc. related to the service to easily create the service without developing software, etc. The created service may then be provided to the service user.

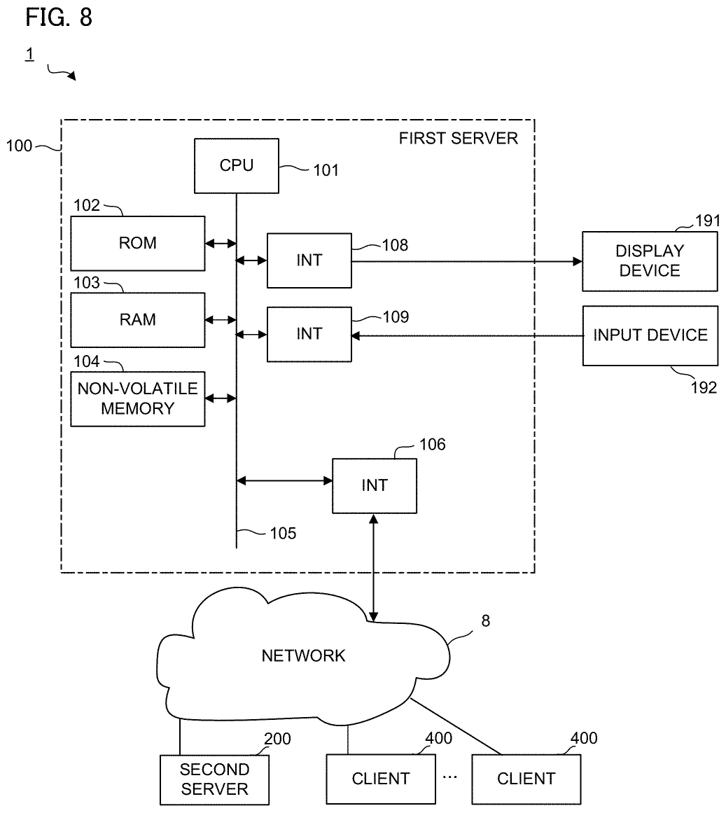

FIG. 8 is a schematic hardware configuration diagram illustrating a main part of the first server 100 included in the cloud system 1 according to the first embodiment of the present invention.

A CPU 101 included in the first server 100 of the present embodiment is a processor that controls the first server 100 as a whole. The CPU 101 reads a system program stored in a ROM 102 via a bus 105, and controls the entire first server 100 according to the system program. Temporary calculation data, display data, various data input from the outside, etc. are temporarily stored in a RAM 103.

A non-volatile memory 104 includes an HDD (Hard Disk Drive), an SSD (Solid State Drive), etc. Data written in the non-volatile memory 104 is retained in a storage state even when the power to the first server 100 is turned off. The non-volatile memory 104 stores data or a program input via an input device 192, each piece of data acquired from other computers such as the second server 200 or the client 400, etc. The data or program stored in the non-volatile memory 104 may be loaded and expanded in the RAM 103 at the time of execution/use. Further, various system programs such as known analysis programs are written in the ROM 102 in advance.

Data read into the memory, data obtained as a result of executing a control program, a system program, etc. are output to a display device 191 via an interface 108 and displayed thereon. Further, the input device 192 including a keyboard, a pointing device, etc. transfers a command, data, etc. based on an operation by an operator to the CPU 101 via an interface 109.

An interface 106 is that for connecting the CPU 101 of the first server 100 to the wired or wireless network 8. Other computers such as the second server 200 and the client 400 are connected to the network 8 to exchange data mutually with the first server 100.

It should be noted that the second server 200 and the client 400 may also include components such as a CPU, a memory, etc. similar to the first server.

A description will be given of functions of the first server 100 and the second server 200 included in the cloud system 1 according to the first embodiment of the present invention with reference to FIG. 3.

The first server 100 included in the cloud system 1 of the present embodiment includes the data reception unit 110, a tool registration unit 120, and the tool store 130. Further, the tool storage unit 150, which is a region for storing a tool provided from the tool provider, is defined in advance on a RAM 13 or a non-volatile memory 14.

The data reception unit 110 can be realized by executing a system program read from the ROM by the CPU included in the first server 100, and mainly performing arithmetic processing using the RAM and non-volatile memory by the CPU, and input/output processing using the display device and the input device, etc. The data reception unit 110 receives information on a tool developed by the tool provider or obtained from any software developer in response to an operation from the tool provider. The data reception unit 110 may receive the tool via an external device (not illustrated), or may receive the tool from another computer via the network 8, for example, in response to an operation from the tool provider.

The tool registration unit 120 can be realized by executing a system program read from the ROM by the CPU included in the first server 100, and mainly performing arithmetic processing using the RAM and non-volatile memory by the CPU, and input/output processing using the display device and the input device, etc. The tool registration unit 120 stores, in the tool storage unit 150, a tool configured based on data related to the tool received by the data reception unit 110. The tool registration unit 120 stores, in the tool storage unit 150, tool provider identification information capable of uniquely identifying the tool provider in association with the tool so that the tool provider registering the tool can be identified. Further, the tool registration unit 120 issues tool identification information capable of uniquely identifying a tool for each tool, and stores the tool identification information in the tool storage unit 150 in association with the tool.

The tool store 130 may be realized by executing a system program read from the ROM by the CPU included in the first server 100, and mainly performing arithmetic processing using the RAM and the non-volatile memory by the CPU, and input/output processing using the network, etc. The tool store 130 sells a tool stored in the tool storage unit 150 to the service provider via the network 8. The tool store 130 has an authentication function for authenticating a service provider, a display function for displaying a list of tools stored in the tool storage unit 150 or displaying a search box for the tools, a license function for issuing a license related to a tool selected by the service provider, and a payment function for performing payment related to purchase of a tool by the service provider, etc. The tool store 130 stores information on the service provider purchasing a tool in the RAM or the non-volatile memory.

The second server 200 included in the cloud system 1 of the present embodiment includes the tool acquisition unit 210, a service creation unit 220, and the service store 230. Further, the service storage unit 250, for storing a service created by the service provider, is provided in advance on a RAM 13 or a non-volatile memory 14.

The tool acquisition unit 210 may be realized by executing a system program read from the ROM by the CPU included in the second server 200, and mainly performing arithmetic processing using the RAM and the non-volatile memory by the CPU, and input/output processing using the display device, the input device, and the network, etc. The tool acquisition unit 210 acquires a tool registered in the first server 100 by the tool provider in response to an operation from the service provider. The tool acquisition unit 210 provides the service provider with an interface for authentication to the first server 100, tool display, tool selection, payment, etc. between the tool acquisition unit 210 and the tool store 130. A tool acquired by the tool acquisition unit 210 is stored in the RAM or the non-volatile memory of the second server 200.

The service creation unit 220 may be realized by executing a system program read from the ROM by the CPU included in the second server 200, and mainly performing arithmetic processing using the RAM and the non-volatile memory by the CPU, and input/output processing using the display device, the input device, and the network, etc. The service creation unit 220 creates a service by executing a function related to service creation included in a tool acquired by the tool acquisition unit 210. The service creation unit 220 executes a service creation wizard, etc. included in the tool, and displays a screen thereof to the service provider. On a service creation screen provided by the tool, the service provider is urged to perform the procedure described in FIGS. 5, 6, 7, etc. and a service can be created without developing a program, etc. Designation of data required for service creation, parameter setting, etc. may be performed by operations on the service creation screen provided by the tool.

Then, when an operation for the service creation wizard by the service provider is completed and a service is created, the created service is stored in the service storage unit 250. The service creation unit 220 stores, in the service storage unit 250, service provider identification information capable of uniquely identifying the service provider in association with the created service so that the service provider creating the service can be identified. Further, the service creation unit 220 issues service identification information capable of uniquely identifying the created service for each service, and stores the service identification information in the service storage unit 250 in association with the service. The service creation unit 220 may store a tool identifier of a tool used for creating a service in the service storage unit 250 in association with the created service.

The service store 230 may be realized by executing a system program read from the ROM by the CPU included in the second server 200, and then mainly performing arithmetic processing using the RAM and the non-volatile memory by the CPU, and input/output processing through the network, etc. The service store 230 sells a service stored in the service storage unit 250 to a service user who operates the client 400 via the network 8. The service store 230 has an authentication function for authenticating a service user, a display function for displaying a list of services stored in the service storage unit 250 or displaying a search box for the services, a license function for issuing a license related to a service selected by the service user, and a payment function for performing payment related to purchase of a service by the service user, etc. The service store 230 stores information on the service provider purchasing the service in the RAM or the non-volatile memory.

In the cloud system 1 according to the present embodiment having the above configuration, the tool provider may sell a tool for constructing various services at the tool store 130, and the service provider may add data and know-bows of own company of the service provider to a tool and provide that obtained tool to a service user through the service store. Therefore, the service provider may provide various services to the service user without any necessity to develop software. In addition, since the service store is used as a service provision method, it is possible to digitize the business related to sales, and it is possible to obtain a digital transformation effect within the company of the service provider.

As a modification of the cloud system 1 according to the present embodiment, the service store 230 included in the second server 200 may feed back to the first server 100 a sales status of the service with respect to the service user. As a result, the tool provider may comprehend a usage status of the tool provided by the tool provider and develop a tool in the future with reference to the usage status.

Further, at this time, the tool store 130 included in the first server 100 may allow the tool provider providing the tool used for creation of the sold service to charge the service provider of the sold service a predetermined allowance based on feedback from the second server 200. As a result, the tool provider may have a part of a fee for selling the service created using the tool provided by the tool provider as income.

As another modification of the cloud system 1 according to the present embodiment, the tool store 130 included in the first server 100 and the service store 230 included in the second server 200 may provide a tool or a service via a shop server (store server) open to the public on a network other than the first server 100 and the second server 200.

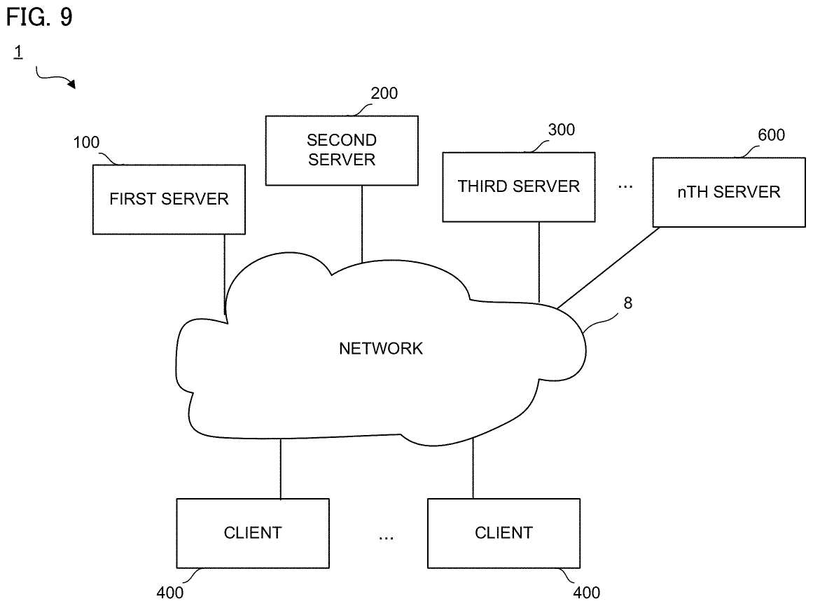

FIG. 9 is a diagram schematically illustrating an overall configuration of a cloud system according to a second embodiment of the present invention. The cloud system 1 according to the present embodiment is configured by further mutually connecting a third server 300 via the network 8 in addition to the first server 100 and the second server 200.

The third server 300 is that supports use of a service purchased from the second server 200. The third server 300 receives provision of one or more services purchased by the service user from the second server 200, and provides a service in which these services and other data processing functions are combined in a complex manner.

This service user may carry out digital transformation (DX) of a company to be used. In addition, this complex combination of services may be sold to the other users through the service store.

For example, the third server 300 may receive data of the factory equipment using the data reception unit via the cloud. By inputting the data to the service, it is possible to provide a factory visualization service, etc. With this service, it is possible to carry out DX such as factory operation management.

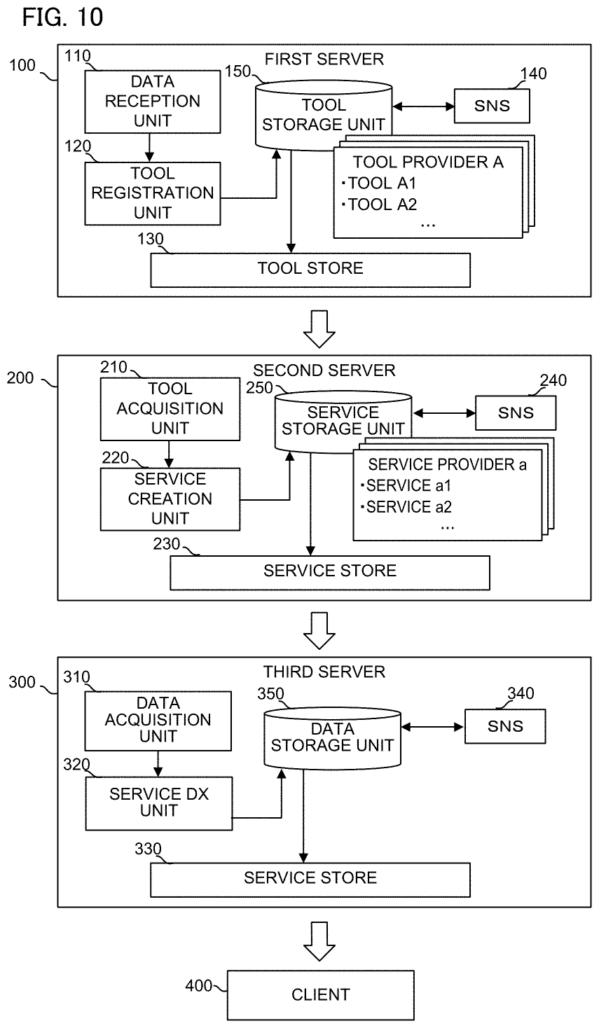

The flow of the service through the first server 100 and the second server 200 will be described with reference to FIG. 10. The third server 300 includes a data acquisition unit 310 that acquires a service from the service store 230 included in the second server 200 via a network. In addition to acquiring a service from the service store 230, the data acquisition unit 310 further acquires data necessary for executing a service via the RAM or the non-volatile memory, the input device, the network, etc. Further, a service DX unit 320 provides a service acquired by the data acquisition unit 310 and a predetermined service using data to a service user who uses the client 400 via a service store 330. For example, the third server 300 may be constructed on a host computer that manages industrial machinery installed at a manufacturing site in a factory, etc., and an analysis service for an operation status provided from a service provider and operation data acquired from each industrial machinery, a sensor, a device, etc. via a network may be combined to provide a service for analyzing a working status of the industrial machine in the factory. At this time, the service DX unit 320 automatically integrates the service and data acquired by the data acquisition unit 310.

In the cloud system 1 according to the present embodiment, the third server 300 simplifies the flow from the purchase to the use of the service by the service user, and thus digital transformation (DX) becomes possible.

Even though one embodiment of the present invention has been described above, the present invention is not limited to the only examples of the above-described embodiment, and may be implemented in various embodiments by making appropriate changes.

### EXPLANATIONS OF LETTERS OR NUMERALS

1 CLOUD SYSTEM
8 NETWORK
100 FIRST SERVER
101 CPU
102 ROM
103 RAM
104 NON-VOLATILE MEMORY
105 BUS
106, 108, 109 INTERFACE
110 DATA RECEPTION UNIT
120 TOOL REGISTRATION UNIT
130 TOOL STORE
140 SNS
150 TOOL STORAGE UNIT
191 DISPLAY DEVICE
192 INPUT DEVICE
200 SECOND SERVER
210 TOOL ACQUISITION UNIT
220 SERVICE CREATION UNIT
230 SERVICE STORE
240 SNS
250 SERVICE STORAGE UNIT
300 THIRD SERVER
310 DATA ACQUISITION UNIT
320 SERVICE DX UNIT
330 SERVICE STORE
340 SNS
350 DATA STORAGE UNIT
400 CLIENT
500 SERVER
510 DATA RECEPTION UNIT
520 DATA ADDITION UNIT
530 SERVICE STORE
540 SNS
550 DATA STORAGE UNIT
600 nTH SERVER

1. A cloud system comprising:
a first server including:
a data reception unit configured to receive information related to a tool;
a tool registration unit configured to register a tool constructed based on the received information related to a tool; and
a tool store configured to provide the registered tool, and
a second server including:
a tool acquisition unit configured to acquire the tool provided by the tool store;
a service creation unit configured to create a service based on the tool and service creation data; and
a service store configured to provide the service created by the service creation unit.

2. A cloud system comprising:
a first server including:
a data reception unit configured to receive information related to a tool;
a tool registration unit configured to register a tool constructed based on the received information related to a tool; and
a tool store configured to provide the registered tool,
a second server including:
a tool acquisition unit configured to acquire the tool provided by the tool store;
a service creation unit configured to create a service based on the tool and service creation data; and
a service store configured to provide the service created by the service creation unit, and
a third server including:
a service acquisition unit configured to acquire the service provided by the service store; and
a service DX unit configured to provide a service using a service using the service.

3. The cloud system according to claim 2, wherein:
the third server includes a data acquisition unit configured to acquire operation data of at least one of a machine, a sensor, and a device via a network; and
the service DX unit provides the service using the operation data acquired by the data acquisition unit.

4. The cloud system according to claim 1, wherein at least one of an acquisition status of the tool by the tool acquisition unit and a provision status of the service by the service store is fed back to the first server.

5. The cloud system according to claim 2, wherein at least one of an acquisition status of the service by the service acquisition unit and a provision status of the service by the service store is fed back to the second server.

6. The cloud system according to claim 1, wherein provision or acquisition of the tool is performed via a store server open to public on a network.

7. The cloud system according to claim 1, wherein provision or acquisition of the service is performed via a store server open to public on a network.

8. The cloud system according to claim 2, wherein at least one of an acquisition status of the tool by the tool acquisition unit and a provision status of the service by the service store is fed back to the first server.

9. The cloud system according to claim 2, wherein provision or acquisition of the tool is performed via a store server open to public on a network.

10. The cloud system according to claim 2, wherein provision or acquisition of the service is performed via a store server open to public on a network.
